(19) United States
(12) Patent Application Publication
(10) Pub. No.: US 2009/0003592 A1
(43) Pub. Date: Jan. 1, 2009

(54) Content delivery system, delivery server, terminal, and content delivery method

(75) Inventor: Tomoyuki Hanai, Kanagawa (JP)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Sony Corporation, Tokyo (JP)

(21) Appl. No.: 12/156,940

(22) Filed: Jun. 5, 2008

(30) Foreign Application Priority Data
Jun. 8, 2007 (JP) P2007-153387

(51) Int. Cl. H04L 9/06

(52) U.S. Cl. 380/29

(57) ABSTRACT

Disclosed herein is a content delivery system which may include a delivery server for delivering content data, a terminal for downloading the content data, and a network. The delivery server may include, an encryption section, and a delivery section. The terminal may include a reception section. The terminal or the delivery server may include an interruption point recording section. The delivery server may include an interruption point acquisition section. Based on the interruption point information, the delivery section may start delivery of one or more of the encrypted blocks that remain to be delivered.

### CROSS-REFERENCE TO RELATED APPLICATIONS

The present application claims priority from Japanese Patent Application No. JP 2007-153387, filed in the Japanese Patent Office on Jun. 8, 2007, the entire content of which is incorporated herein by reference.

### BACKGROUND OF THE INVENTION

1. Field of the Invention

The present invention relates to a content delivery system, a delivery server, a terminal, and a content delivery method.

2. Description of the Related Art

In recent years, use of content delivery services has become common. In the content delivery services, content data, such as movie, music, or software data, is delivered via a network, such as the Internet.

The content delivery services are generally composed of a delivery server and a user terminal, which are both connected to a network. The delivery server has stored therein a plurality of pieces of content data, and, in response to access from the user terminal, delivers content data to the user terminal. On the other hand, the user terminal accesses the delivery server via the network, and downloads the content data from the delivery server. For example, a user can operate the user terminal to access the delivery server and thus download the content data from the delivery server.

As a technique in which data is downloaded from a server to a terminal, Japanese Patent Laid-open No. 2004-297479 (hereinafter referred to as Patent Document 1) discloses a technique in which a portable communication terminal, which is an example of the user terminal, downloads data via a wireless base station and a network, for example.

### SUMMARY OF THE INVENTION

When the content data is delivered from the delivery server to the user terminal via the network, the data delivery is sometimes interrupted because of heavy traffic on the network or depending on an operating state of the delivery server, for example. As a result, the download of the data may be interrupted in the user terminal. When this happens, in related art, the terminal is not capable of resuming the download so as to continue from a point at which the download was interrupted. In other words, in related art, the terminal is not capable of downloading only the remaining part of the data, which has not been downloaded yet, and needs to start the download again from the top of the content data.

In related art, if the download is interrupted during the delivery of the content data from the delivery server to the terminal, it is necessary to start the download again from the top of the content data. Accordingly, completion of the download of the entire data may take a long time. Moreover, when resuming the download of the content data after the download is interrupted, the user needs to operate the terminal in order to transmit a request for starting the download to the delivery server.

Still further, because the download of the content data needs to be started again from the top of the content data, the data that was transferred over the network before is transferred again over the network. This means an inefficient use of the network.

In the technique as disclosed in Patent Document 1 mentioned above, the wireless base station stores an interruption point of the content data when the download of the content data, requested by the terminal, has been interrupted. Thereafter, instead of the terminal, the wireless base station receives, from the server, that part of the content data which follows the interruption point and stores this part of the content data, and when requested from the terminal, the wireless base station transmits that part of the content data which follows the interruption point to the terminal. As such, in this technique, a storage section configured to storing data and a control section configured to control data transmission and reception need to be additionally provided within the wireless base station, instead of in the delivery server and the terminal. In addition, management of the wireless base station is additionally required, resulting in increased complexity of the management of the content delivery service as a whole.

According to an embodiment of the present invention, there is provided a content delivery system, which may include:

a delivery server configured to deliver content data;

a terminal configured to download the content data from the delivery server; and

a network to which the delivery server and the terminal are connected, wherein

the delivery server includes,

an encryption section configured to perform block encryption on the content data to divide the content data into a plurality of encrypted blocks and add point information to each of the encrypted blocks, and

a delivery section configured to deliver the content data to the terminal on an encrypted block by encrypted block basis,

the terminal includes a reception section configured to receive the content data delivered from the delivery section on an encrypted block by encrypted block basis,

the terminal or the delivery server includes an interruption point recording section configured to, when reception of the content data has been interrupted in the terminal, record the point information of a last encrypted block that has been received as interruption point information,

the delivery server includes an interruption point acquisition section configured to acquire the interruption point information recorded in the interruption point recording section, and

based on the interruption point information acquired by the interruption point acquisition section, the delivery section starts delivery of one or more of the encrypted blocks of the content data that remain to be delivered to the terminal.

According to another embodiment of the present invention, there is provided a delivery server for delivering content data to a terminal for downloading the content data via a network, the delivery server may include:

an encryption section configured to perform block encryption on the content data to divide the content data into a plurality of encrypted blocks and add point information to each of the encrypted blocks;

a delivery section configured to deliver the content data to the terminal on an encrypted block by encrypted block basis; and

an interruption point acquisition section configured to, when reception of the content data has been interrupted in the terminal, acquire the point information of a last encrypted block that has been received by the terminal as interruption point information, wherein

based on the interruption point information acquired by the interruption point acquisition section, the delivery section starts delivery of one or more of the encrypted blocks of the content data that remain to be delivered to the terminal.

According to yet another embodiment of the present invention, there is provided a terminal for downloading content data from a delivery server for delivering the content data via a network, the content data having been subjected to block encryption in the delivery server so that the content data has been divided into a plurality of encrypted blocks and point information has been added to each of the encrypted blocks, the terminal may include:

a reception section configured to receive the content data from the delivery server on an encrypted block by encrypted block basis, wherein

when reception of the content data has been interrupted in the terminal, the reception section starts reception of one or more of the encrypted blocks of the content data that remain to be received based on interruption point information, the interruption point information being the point information of a last encrypted block that has been received.

According to yet another embodiment of the present invention, there is provided a content delivery method employed in a network to which a delivery server for delivering content data and a terminal for downloading the content data are connected, the method including:

the delivery server performing block encryption on the content data to divide the content data into a plurality of encrypted blocks and add point information to each of the encrypted blocks;

the delivery server delivering the content data to the terminal on an encrypted block by encrypted block basis;

the terminal receiving the content data delivered from the delivery server on an encrypted block by encrypted block basis;

when reception of the content data has been interrupted in the terminal, the terminal or the delivery server recording the point information of a last encrypted block that has been received as interruption point information;

the delivery server acquiring the interruption point information recorded in the recording step; and

based on the interruption point information acquired in the acquiring step, the delivery server starting delivery of one or more of the encrypted blocks of the content data that remain to be delivered to the terminal.

According to the embodiments of the present invention, when the transfer of the content data has been interrupted, the transfer of the content data can be resumed quickly and easily from the interruption point.

### BRIEF DESCRIPTION OF THE DRAWINGS

FIG. 1 is a block diagram illustrating a content delivery system according to a first embodiment of the present invention;

FIG. 2 is a block diagram illustrating a reception terminal according to the first embodiment;

FIG. 3 is a block diagram illustrating an encryption process performed by a delivery server according to the first embodiment;

FIG. 4 is a diagram illustrating a data structure of a media file of content data according to the first embodiment;

FIG. 5 is a sequence diagram illustrating an operation of the content delivery system according to the first embodiment;

FIGS. 6A and 6B are flowcharts illustrating the operation of the content delivery system according to the first embodiment;

FIGS. 7A, 7B and 7C are diagrams illustrating a download sequence of the content delivery system according to the first embodiment; and

FIGS. 8A and 8B are diagrams illustrating a sequence of reproducing a downloaded content according to the first embodiment.

### DETAILED DESCRIPTION

Hereinafter, a preferred embodiment of the present invention will be described in detail with reference to the accompanying drawings. Note that, in the present specification and the accompanying drawings, like reference numerals designate like parts, and thus redundant descriptions will be omitted.

### Structure of First Embodiment

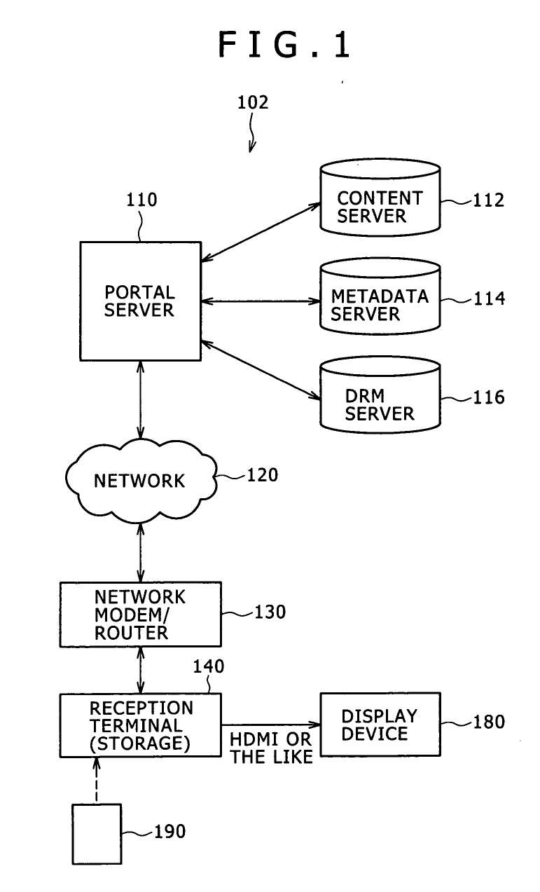

First, a content delivery system 100 according to a first embodiment of the present invention will now be described below with reference to FIG. 1. FIG. 1 is a block diagram illustrating the content delivery system 100 according to the present embodiment. The content delivery system 100 is a system for delivering content data, such as movie, music, sports, or software data, via a network such as the Internet. The content delivery system 100 includes a delivery server 102 and a reception terminal 140 (i.e., a user terminal), which are both connected to a network 120. The content delivery system 100 implements a content delivery service, in which the content data is delivered to the user terminal or the user terminal is capable of downloading the content data.

The network 120 is, for example, a wide-area IP network in which computer networks are interconnected using Internet protocol (IP) technology. The network 120 includes a closed domain network in which restrictions are placed on the purpose of use of the computer network, users, and so on. A network modem/router 130 is connected to the network 120 and the reception terminal 140, for example, and a modem performs modulation and demodulation on a digital or analog signal between the network 120 and the reception terminal 140, while a router connects different computer networks or controls a path between the different computer networks.

As shown in FIG. 1, the delivery server 102 includes a portal server 110, a content server 112, a metadata server 114, and a DRM server 116. The content server 112, the metadata server 114, and the DRM server 116 are connected to the portal server 110. In the present embodiment, it is assumed that the delivery server 102 is composed of separate computer servers, i.e., the portal server 110, the content server 112, the metadata server 114, and the DRM server 116. Note, however, that, in another embodiment of the present invention, the delivery server 102 may be formed by a single computer server (i.e., a single piece of hardware) that has features of all the above four servers. Also note that each of the portal server 110, the content server 112, the metadata server 114, and the DRM server 116 may be either formed as a single piece of hardware or composed of two or more pieces of hardware.

Each of the portal server 110, the content server 112, the metadata server 114, and the DRM server 116, which combine to form the delivery server 102, is formed by a computer device or the like that has a server function and includes a central processing unit (CPU), a memory, storage, an input/output interface (IF), a communication interface (IF), and a display section. Because the portal server 110, the content server 112, the metadata server 114, and the DRM server 116 have common components, they will be described collectively.

The CPU functions as a processor and a controller in accordance with a program, and is capable of controlling processes performed by the components within the server. The memory is, for example, formed by a storage section such as a random access memory (RAM), a read only memory (ROM), or a cache memory. The memory has a function of temporarily storing data related to processing by the CPU, an operation program for the CPU, and so on. The storage is, for example, formed by a hard disk drive (HDD), a flash memory, or the like. The storage is a storage section configured to store data on a long-term basis. The storage is capable of storing data such as user information, terminal performance information, network line information, and a program.

The input/output IF is, for example, formed by: an operation section, such as a mouse, a keyboard, a touch panel, a button, a switch, or a lever; an input control section that generates an input signal and outputs the generated input signal to the CPU; and so on. For example, an administrator of the delivery server 102 can operate the operation section of the input/output IF to input data to the server or issue an instruction as to a processing operation of any of the servers. The communication IF is, for example, formed by a communication line, a communication circuit, a communication device, or the like. The communication IF is capable of transferring the data between each pair of the servers or between the reception terminal 140 and the server via the computer network.

The display section is, for example, including: a display device for presenting a display based on a video signal; an audio output device for outputting an audio based on an audio signal; and so on. Examples of the display device include a liquid crystal display (LCD), a CRT display, and a lamp. Examples of the audio output device include a loudspeaker. For example, using the display section, the administrator of the delivery server 102 is able to check a result of an operation that he or she has performed using the input/output IF.

The portal server 110 verifies whether the reception terminal 140 meets a requirement for using the content delivery service. Also, the portal server 110 provides, to the reception terminal 140, navigation information concerning contents that can be enjoyed by using the content delivery service. The portal server 110 is capable of receiving a request from the reception terminal 140, and transmitting data to the content server 112, the metadata server 114, or the DRM server 116 in accordance with the request. Also, the portal server 110 is capable of receiving data from the content server 112, the metadata server 114, and the DRM server 116, and transmitting the data to the reception terminal 140 via the network 120.

The storage in the portal server 110 may include an interruption point recording section. When reception of the content data has been interrupted at the terminal, the interruption point recording section records, as interruption point information, point information of the last encrypted block that has been received successfully by the terminal.

The CPU in the portal server 110 includes an encryption section, a delivery section, and an interruption point acquisition section. As described below, the encryption section performs block encryption on the content data to divide the content data into a plurality of encrypted blocks and add point information to each of the encrypted blocks. The delivery section delivers the content data to the reception terminal 140 on an encrypted block by encrypted block basis. The interruption point acquisition section acquires the interruption point information recorded in the interruption point recording section, which is provided in the portal server 110 or the reception terminal 140.

When the reception of the content data has been interrupted at the terminal, the delivery section suspends the delivery of the content data for a predetermined period of time (a standby mode). Further, when the predetermined period of time has elapsed in the standby mode, the delivery section starts delivery of remaining encrypted blocks of the content data, based on the interruption point information acquired by the interruption point acquisition section (a resume mode). The remaining encrypted blocks of the content data correspond to that part of the content data which remains to be delivered to the terminal. Even if the resume mode is started, the terminal may be unable to resume the reception of the content data because a cause for the interruption has not been eliminated yet. In that case, the delivery section shifts back to the standby mode and, after the predetermined period of time elapses, shifts to the resume mode again. This shift from the standby mode to the resume mode and back again to the standby mode may be repeated many times. When this back-and-forth mode shift has been repeated a predetermined number of times as a result of the inability to resume the reception of the content data at the terminal in the resume mode, the delivery section starts delivery or the content data from the top of the content data.

The content data, such as the movie, music, sports, or software data, is stored in the storage of the content server 112. In response to the request from the reception terminal 140, the content server 112 transmits the content data to the reception terminal 140 via the portal server 110.

In the case where the content server 112 transmits a video content, such as a movie or sports content, the content server 112 encodes data of the video content into an MPEG-2, MPEG-4, or QuickTime format, and transmits the encoded data to the reception terminal 140. Note that applicable encoding systems are not limited to MPEG-2, MPEG-4, and QuickTime systems.

In the case where the content server 112 transmits an audio content, such as a music content, the content server 112 encodes data of the audio content using MPEG-1 Audio Layer-3 (MP3), adaptive transform acoustic coding (ATRAC), or the like, and transmits the encoded data to the reception terminal 140. Note that applicable encoding systems are not limited to MP3 and ATRAC.

The content server 112 transmits a reproduction control metafile to the reception terminal 140. The reproduction control metafile is used when the content data is reproduced after the reception terminal 140 stores the content data. in the case of the video content, for example, the reproduction control metafile corresponds to time data that represents a start point of a chapter, a good scene in the content, and so on.

Metadata concerning the content data is stored in the storage of the metadata server 114. The metadata server 114 transmits, to the reception terminal 140, metadata corresponding to the content requested by the reception terminal 140. Here, the “metadata” refers to data concerning the content, such as a title, a creation date, a person that appears in the content, a summary, or a genre of the content, a period in which the content is available for delivery, or the like.

The DRM server 116 assumes digital rights management (DRM) of the contents to be delivered. The DRM server 116 receives from the reception terminal 140 a request to issue a license related to the content data, and determines whether the reception terminal 140 meets a requirement for issuance of the license. If the DRM server 116 determines that the reception terminal 140 meets the requirement for the issuance of the license, the DRM server 116 issues the license to the reception terminal 140. In general, even if the content data is downloaded from the content server 112 to the reception terminal 140, the content data cannot be reproduced without the license. Only when a proper license has been acquired by meeting a user requirement or the like, the reception terminal 140 is able to reproduce the content data. A detailed description of the digital rights management is omitted, because common methods of the digital rights management are applicable to the embodiment of the present invention. Note that other methods of the digital rights management than that described above are also applicable to the embodiment of the present invention.

The reception terminal 140 is connected to the network 120. Examples of the reception terminal 140 including: a personal computer; a tuner containing a radio receiver, a television receiver, or the like; a set-top box that is capable of receiving IP broadcasting via cable television, television broadcasting, or the network. The reception terminal 140 includes a CPU 156, a memory, storage 158, a communication interface (IF) 164, and so on.

The reception terminal 140 transmits, to the portal server 110 via the network 120, a request to download the content data. The reception terminal 140 receives, via the portal server 110, the content data recorded in the content server 112, the metadata recorded in the metadata server 114, the license issued by the DRM server 116, and so on. The reception terminal 140 is connected to a display device 180. The reception terminal 140 performs control so that the content, a graphical user interface (GUI), or an electronic content guide (ECG) will be displayed on the display device 180.

The GUI provides a screen that is so arranged as to facilitate user operation when the content data is an electronic book, a game, software, or the like. Using the metadata, the ECG provides a navigation function in connection with a list of contents that are downloadable from the delivery server 102, a list of contents that have already been purchased and are now viewable with the reception terminal 140, detailed information concerning the contents, or the like.

Examples of the display device 180 include a display for a computer terminal and a television. The display device 180 is, for example, composed of: a display device for presenting a display based on a video signal; an audio output device for outputting an audio based on an audio signal; and so on. Examples of the display device include the liquid crystal display (LCD), a plasma display, and the CRT display. Examples of the audio output device include the loudspeaker.

The display device 180 is connected to the reception terminal 140, and receives data from the reception terminal 140 to reproduce the video and audio related to the content or display a GUI screen or an ECG screen, for example. An interface, such as a High-Definition Multimedia Interface (HDMI), is provided between the reception terminal 140 and the display device 180 for transmission and reception of the video signal, the audio signal, and a control signal. Note that the reception terminal 140 and the display device 180 may be independent of each other, or alternatively the reception terminal 140 and the display device 180 may be integrated into a single unit.

A remote control 190 is an example of an operation section used for operating the reception terminal 140. The reception terminal 140 can be remotely controlled by using the remote control 190. The remote control 190 can be used to control a reproducing operation of an AV player 176, or to perform an operation on a BML browser or the ECG. Note that the operation section for the reception terminal 140 is not limited to the remote control 190. For example, the operation section may be provided on the reception terminal 140.

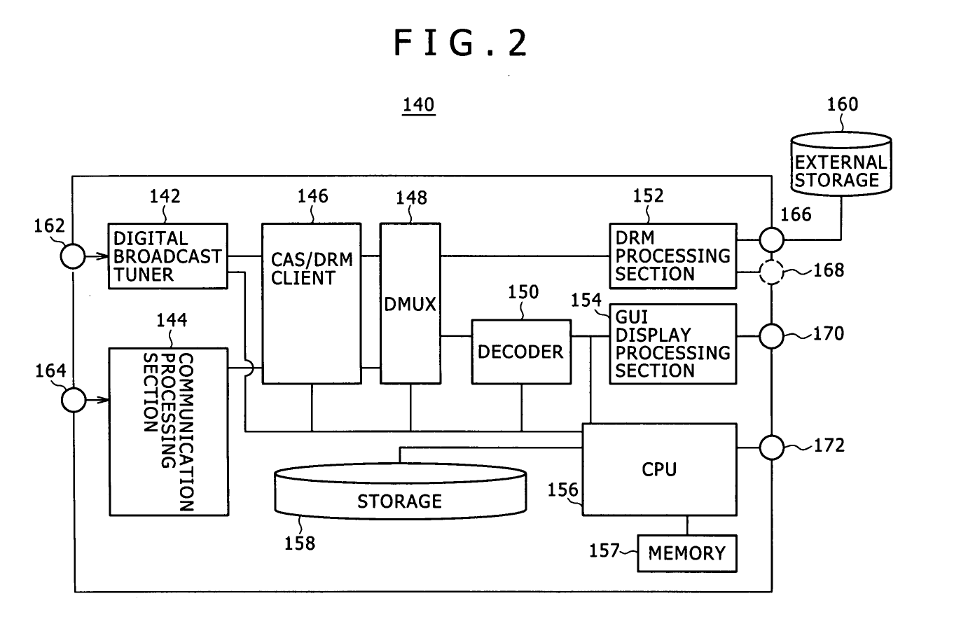

Next, the reception terminal 140 according to the present embodiment will now be described in detail below with reference to FIG. 2. FIG. 2 is a block diagram illustrating the reception terminal 140 according to the present embodiment.

As shown in FIG. 2, the reception terminal 140 includes a digital broadcast tuner 142, a communication processing section 144, a CAS/DRM client section 146, a DMUX 148, a decoder 150, a DRM processing section 152, a GUI display processing section 154, the CPU 156, and the storage 158.

The digital broadcast tuner 142 receives a (BS, CS, or terrestrial) digital broadcast, and provides an output to various functional blocks in the reception terminal 140. The digital broadcast tuner 142 receives a broadcast signal of digital broadcasting via an antenna wire/broadcast interface (IF) 162. Because the digital broadcast tuner 142 is provided in the reception terminal 140, the reception terminal 140 is capable of receiving a television broadcast via the antenna wire, in addition to the television broadcast provided by the IP broadcasting. Note that the reception terminal 140 does not need to include the digital broadcast tuner 142 in another embodiment of the present invention.

The communication processing section 144 performs communication control using RTP, UDP, HTTP/TLS, RTSP, TCP, IP, IGMP/MLD, or other protocols. The communication processing section 144 receives a signal via the communication interface (IF) 164, such as an Ethernet interface, and provides an output to various functional blocks in the reception terminal 140. The communication processing section 144 compensates jitter that occurs in network communication or perform an FEC process in connection with streaming data that is sent using UDP.

RTP stands for Real-time Transport Protocol. FEC stands for Forward Error Correction. UDP stands for User Datagram Protocol. HTTP stands for Hypertext Transfer Protocol. TLS stands for Transport Layer Security in Secure Socket Layer (SSL). RTSP stands for Real Time Streaming Protocol. TCP stands for Transmission Control Protocol. IP stands for Internet Protocol. IGMP/MLD stands for Internet Group Management Protocol/Multicast Listener Discovery. The above network protocols are in common use, and therefore detailed descriptions thereof are omitted.

The CAS/DRM client section 146 acquires the license from a CAS server or the DRM server 116. The CAS/DRM client section 146 decrypts transferred data as encrypted or the content data as encrypted, which has been received. The CAS/DRM client section 146 manages digital broadcast contents in accordance with a conditional access system (CAS), and decrypts the content data encrypted by the digital rights management (DRM). Note that the CAS/DRM client section 146 may include a descrambler and a decryptor. The CAS/DRM client section 146 receives data outputted from the digital broadcast tuner 142 or the communication processing section 144, and outputs a signal obtained by decryption to the DMUX 148 or the like.

The DMUX 148 performs a demultiplexing process. The DMUX 148 receives the signal obtained by decryption from the CAS/DRM client section 146, and separates the received data into signals, such as a video signal, an audio signal, subtitle data, program specific information (PSI)/service information (SI), etc.

The decoder 150 decodes the signals subjected to the demultiplexing process. Examples of the decoder 150 include: a video decoder for decoding the video data; an audio decoder for decoding the audio data; and a subtitle decoder for decoding the subtitle data.

In the case where the video signal, the audio signal, and other data obtained by the demultiplexing process are outputted to external storage 160 and stored in the external storage 160, the DRM processing section 152 performs an encryption process on the video signal, the audio signal, and the other data. This encryption process makes it possible to allow the content data to be reproduced only by specific reception terminals. Thus, even if the external storage is connected to another reception terminal, the content data cannot be reproduced by this reception terminal unless this reception terminal is authorized to reproduce the content data. The data encrypted by the DRM processing section 152 is outputted to the external storage 160 or a removable medium via an input/output interface (IF) 166 or 168. Examples of the external storage 160 include a hard disk drive. Examples of the removable media include optical disk drives designed for compact discs, DVDs, and so on.

The GUI display processing section 154 performs a process of reproducing data using the video signal decoded by the video decoder, and performs a process of combining display data for a browser, an EPG, the ECG, or the like, thereby generating data that will be presented on the display device 180 for a user to view. The data generated by the GUI display processing section 154 is outputted to the display device 180 via a video/audio output interface (IF) 170.

The CPU 156 functions as a processor and a controller in accordance with a program, and is capable of controlling processes performed by each of the components of the reception terminal 140. The CPU 156 controls various applications, such as the browser, executed on the reception terminal 140. The CPU 156 also controls the download of the content data, the storage of the downloaded content data in the storage, the reproduction of the content data stored in the storage 158, and so on.

The CPU 156 in the reception terminal 140 includes a decryption section and a reception section. In the case where the interruption point recording section is provided in the reception terminal 140, the reception terminal 140 includes an interruption point notification section. The decryption section decrypts the content data, which has been subjected to the block encryption so that the original content data has been divided into the plurality of encrypted blocks and the point information has been added to each of the encrypted blocks, to recover the original (i.e., pre-encrypted) content data. The reception section receives the content data delivered from the delivery server 102 on an encrypted block by encrypted block basis. The interruption point notification section notifies the interruption point acquisition section in the delivery server 102 of the interruption point information recorded in the interruption point recording section in the storage 158.

Examples of the applications executed by the CPU 156 include a browser 174 and the AV player 176.

An example of the browser 174 is a broadcast markup language (BML) browser. The BML browser is software for reproducing contents described in BML. The BML can be used to control the display presented on a screen of the display device 180 (e.g., to control what should be displayed on which part of the screen and when it should be displayed), and to specify a user interface that contains a link to a related program, a link to an URL on the Internet, a title, a main text, an operation button, and so on, for example.

The browser 174 displays the downloadable contents, the list of contents, and the like on the display device 180, so that the user is able to select a content that the user desires to download.

The AV player 176 performs a process of reproducing the content data, such as the video data or the audio data. The AV player 176 is capable of controlling operations related to the content data, such as reproduction start, stop, fast-forwarding, and rewinding, for example.

The storage 158 stores the content data downloaded to the reception terminal 140 as a result of the CPU 156 controlling the download and storage of the content data. The storage 158 is formed by a hard disk drive (HDD), a flash memory, or the like, for example. The storage 158 is a storage section configured to store data on a long-term basis.

The storage 158 may include the interruption point recording section. When the reception of the content data has been interrupted in the terminal, the interruption point recording section records, as the interruption point information, the point information of the last encrypted block that has been received successfully by the terminal. In the case where the interruption point recording section is provided in the reception terminal 140, the reception terminal 140 can assume download management, and thus the management on the part of the delivery server 102 becomes simpler.

Note that, as described above, the storage in the delivery server 102 may also include the interruption point recording section. In the case where both the delivery server 102 and the reception terminal 140 include the interruption point recording section, the download can be resumed at the interruption point when a trouble has occurred in either the delivery server 102 or the reception terminal 140. In the case where both the delivery server 102 and the reception terminal 140 include the interruption point recording section, a determining section may be additionally provided for determining whether the interruption points recorded in the two interruption point recording sections are identical or different. Note that the interruption point recording section may be provided in only one of the delivery server 102 and the reception terminal 140.

The reception terminal 140 further includes a memory 157 and an input/output interface (IF) 172. The memory 157 is formed by a storage section such as a random access memory (RAM), a read only memory (ROM), or a cache memory. The memory 157 has a function of temporarily storing data related to processing by the CPU, an operation program for the CPU, and so on. The input/output IF is, for example, formed by: an operation section, such as a mouse, a keyboard, a touch panel, a button, a switch, or a lever; an input control section that generates an input signal and outputs the generated input signal to the CPU; and so on. For example, the user can operate the operation section of the input/output IF to input data to the reception terminal 140 or issue an instruction as to a processing operation of the reception terminal 140.

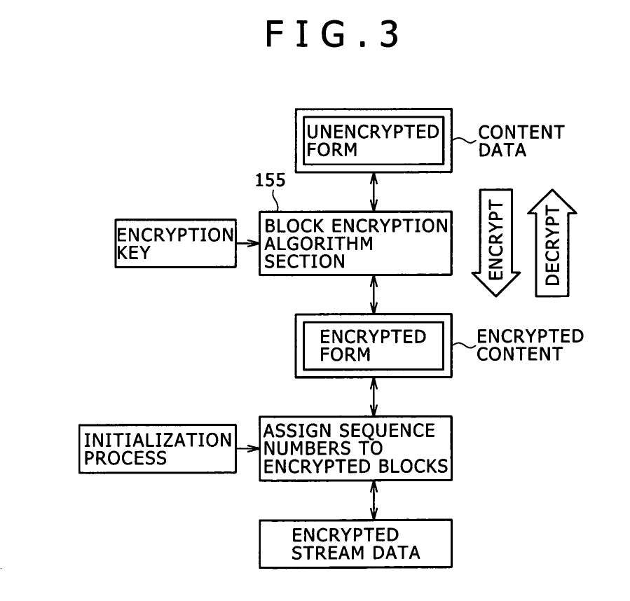

Next, the process of encrypting the content data in the delivery server 102 will now be described below with reference to FIG. 3. FIG. 3 is a block diagram illustrating the encryption process performed by the delivery server 102 according to the present embodiment.

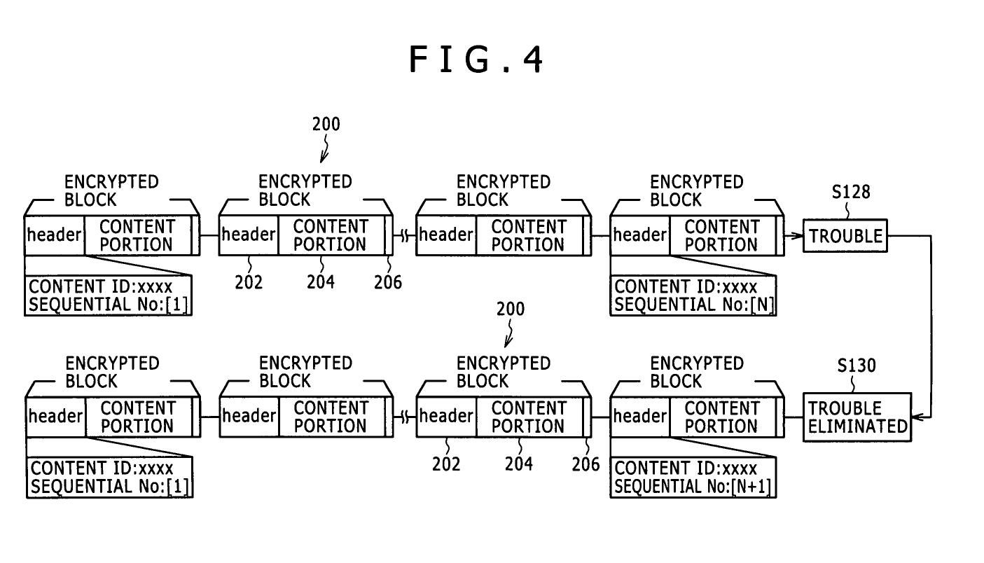

The content data is stored in unencrypted form. The unencrypted content data is encrypted by a block encryption algorithm section 155 using an encryption key. As a result of this encrypting process by the block encryption algorithm section 155, an encrypted content in encrypted form is generated. As will be described below with reference to FIG. 4, the encrypted content is separated into encrypted blocks 200. Then, an initialization process is performed on each of the encrypted blocks 200, and a sequential number (No) is assigned to a header portion 202 of each of the encrypted blocks 200. As a result of assigning the sequential numbers to the header portions 202 of all the encrypted blocks 200, encrypted stream data is generated. Note that the encrypted content in encrypted form can be converted back to the content data in unencrypted form by applying a block encryption algorithm inversely.

Next, a data structure of an encrypted media file will now be described below. FIG. 4 is a diagram illustrating a data structure of a media file of the content data according to the present embodiment.

Data of the media file of each piece of content data is divided into a plurality of encrypted blocks (packets) 200. Each of the encrypted blocks 200 is composed of the header portion 202, a content portion 204, and an end portion 206, for example. In the header portion 202, a content ID of the content data and the sequential number of the encrypted block 200 are stored. The content ID of the content data is information representing the media file of the content data. The sequential number of the encrypted block 200 is information representing a data location of the encrypted block 200. The sequential number assigned to the first encrypted block 200 in the content data is “1”, and consecutively increasing sequential numbers are assigned to the remaining encrypted blocks 200. The sequential numbers are an example of the point information.

Actual data of the content is recorded in the content portion 204. Check-use data, which is used for verifying that the download of the corresponding encrypted block 200 has been completed, is recorded in the end portion 206. For example, if the reception terminal 140 recognizes that the check-use data of the encrypted block 200 with sequential number [N] has been stored in the storage 158, the reception terminal 140 determines that the download of sequential number [N] has been completed.

The case will now be described below where a trouble has occurred while the download of the media file is in progress. Suppose that the download of data of the encrypted block 200 with sequential number [N] has been completed, and a trouble has occurred when the download of the encrypted block 200 with sequential number [N+1] is in progress. In this case, the encrypted block 200 with sequential number [N+1] and the following encrypted blocks 200 have not been downloaded yet. Accordingly, in the present embodiment, the download of the remaining encrypted blocks 200 is resumed with the encrypted block 200 with sequential number [N+1] after the trouble is eliminated. Thus, the download of the media file is efficient in the present embodiment. FIG. 4 shows a data array of the media file in the case where the trouble has occurred after the download of the encrypted blocks with sequential numbers [1] to [N] is completed, and after the trouble has been eliminated, the encrypted blocks with sequential numbers [N+1] to [END] (i.e., the last sequential number) have been downloaded.

In the present embodiment, the sequential numbers recorded in the header portions are used as the point information. Note, however, that the point information is not limited to the sequential numbers in the embodiment of the present invention. Other examples of the point information include: packet information that is recorded in each of the encrypted blocks and which is managed by the delivery server; address information of a file system; a total data amount counted from the top of the media file; and data information in the actual content data. Also note that, in the present embodiment, the information representing the media file of the content data is the content ID of the content data, but the embodiment of the present invention is not limited to this example. For example, the information representing the media file of the content data may be a file name of the content data or a URL. Also note that the location where the point information is recorded is not limited to the header portion 202. The point information may be recorded in the content portion 204 or other locations, alternatively.

### Operation of First Embodiment

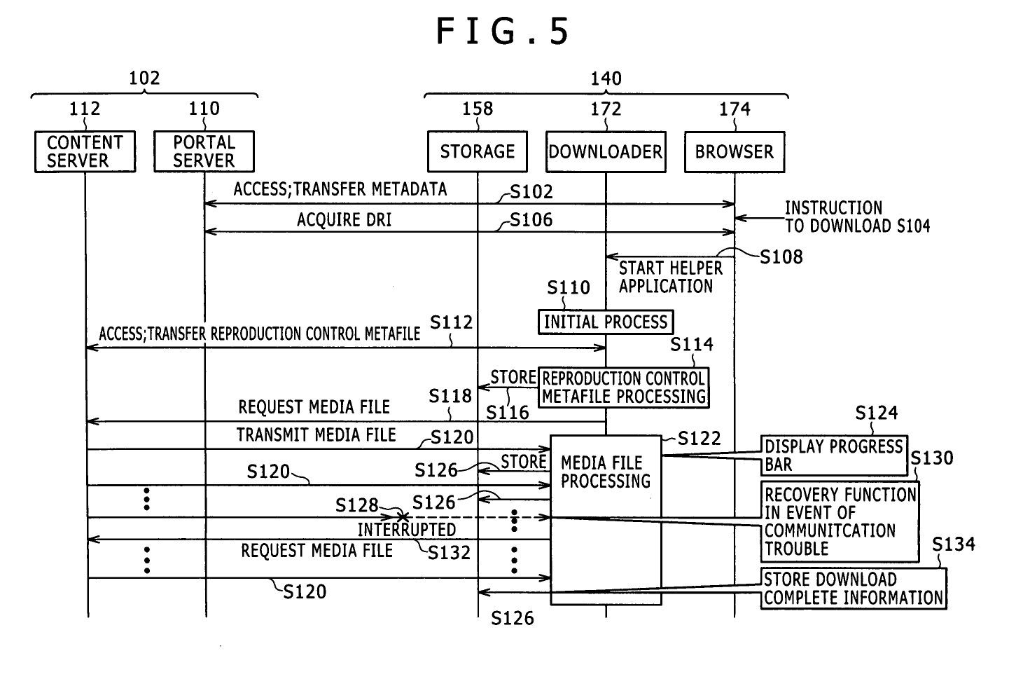

Next, an operation of the content delivery system 100 according to the present embodiment will now be described below. FIG. 5 is a sequence diagram illustrating the operation of the content delivery system 100 according to the present embodiment.

First, as a result of an operation by a user who desires to use the content delivery system 100, the reception terminal 140 accesses the delivery server 102. At this time, the browser 174 in the reception terminal 140 accesses the portal server 110 based on a destination of a selected link. Then, if the portal server 110 authenticates the reception terminal 140, the portal server 110 transmits the metadata to the reception terminal 140. The reception terminal 140 acquires the metadata transmitted from the portal server 110 (step S102). Then, based on the acquired metadata, the browser 174 in the reception terminal 140 displays the list of contents or the like on the display device 180. Next, based on the displayed list, the user issues an instruction to download a desired content to the reception terminal 140 so that the reception terminal 140 requests the delivery server 102 to deliver the desired content (step S104). After the issuance of the instruction to download, the browser 174 acquires digital right information (DRI) from the portal server 110 (step S106). Here, the DRI refers to DRM information of the content. The DRI is, for example, a file in which terms of use, such as a time limit for the reproduction of the content, are described.

Next, the browser 174 starts a helper application, such as a downloader 172 (step S108). The downloader 172 performs a process of downloading the content data. As an initial process, the downloader 172 checks free space in the storage 158, analyzes the acquired DRI, and generates a storage directory for storing the media file (i.e., the content data) (step S110). After the initial process, the downloader 172 accesses the content server 112 via the portal server 110 to acquire the reproduction control metafile from the content server 112 (step S112). The reproduction control metafile will be used, after the content data is stored in the reception terminal 140, for control of a reproduction start position and the like when reproducing the content data.

The downloader 172 performs a process of controlling storage of the acquired reproduction control metafile (step S114), so that the downloader 172 stores the reproduction control metafile in the storage 158 (step S116).

Next, the downloader 172 requests, from the content server 112, the media file of the content data desired by the user (step S118). Then, in response to this request from the reception terminal 140, the content server 112 transmits the media file to the reception terminal 140 (step S120).

The downloader 172 starts downloading the media file, thereby starting media file processing (step S122). While the download is in progress, the downloader 172 displays a progress bar for indicating how far the download has progressed (step S124). While the delivery of the media file is in progress, the progress bar is displayed to indicate how far the download of the desired media file has progressed in terms of a percentage (%) of the amount of data already downloaded to the total data amount of the media file, for example.

The downloader 172 stores the received media file in the storage 158 (step S126). As described below, the media file is delivered (downloaded) on an encrypted block by encrypted block basis and thus stored in the storage 158. The processes of steps S120 and S126 are repeated to progress the delivery of the media file.

The download is completed when it has been determined, based on the content meta information (i.e., the metadata) already downloaded, that the last sequential number of the media file has been stored. However, while the delivery of the media file is in progress, a trouble or the like may occur in the content delivery system 100, so that the delivery of the media file is interrupted (step S128). If the reception terminal 140 detects the interruption, the reception terminal 140 shifts to a standby mode, in which the reception terminal 140 suspends the reception of the content. At this time, the interruption point is recorded in the interruption point recording section in the reception terminal 140.

Then, in the reception terminal 140, a recovery function attempts to eliminate the trouble in the content delivery system 100, such as a trouble of no response being returned from the server or a network trouble (step S130). The recovery function, which works in the event of a communication trouble, identifies which of the system components, such as the content server 112, the reception terminal 140, and the network 120, is a cause of the trouble. In the case where the reception terminal 140 is the cause of the trouble, the trouble is eliminated by a program if the trouble is a kind of trouble that can be recovered using the program, whereas the trouble will be eliminated by human work if the human work is needed to eliminate the trouble.

When the predetermined period of time has elapsed after the reception terminal 140 entered the standby mode, the reception terminal 140 shifts to a resume mode. In the resume mode, the reception terminal 140 accesses the delivery server 102 regularly to request the delivery of the media file based on the interruption point recorded in the interruption point recording section. At this time, the downloader 172 transmits the interruption point information to the content server 112 and makes a request for the media file based on URL information of the content, for example (step S132). If the trouble in the content delivery system 100 has been eliminated, the delivery of the media file is resumed (step S120).

If the download of the media file of the content selected by the user is completed entirely after the elimination of the trouble and the resuming of the delivery, the downloader 172 stores download complete information in the storage 158 (step S134). Thus, the media file processing of the downloader 172 is completed.

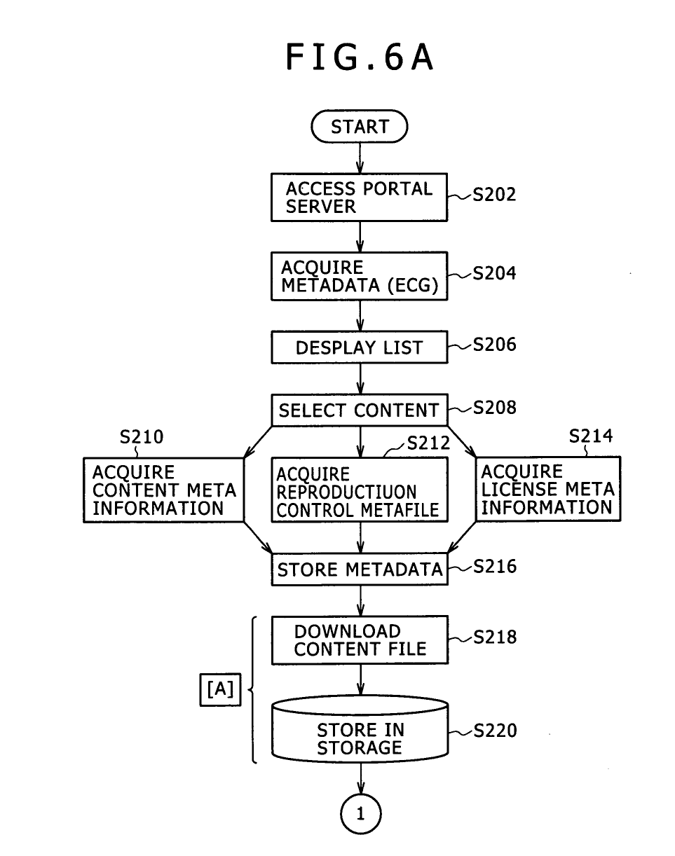

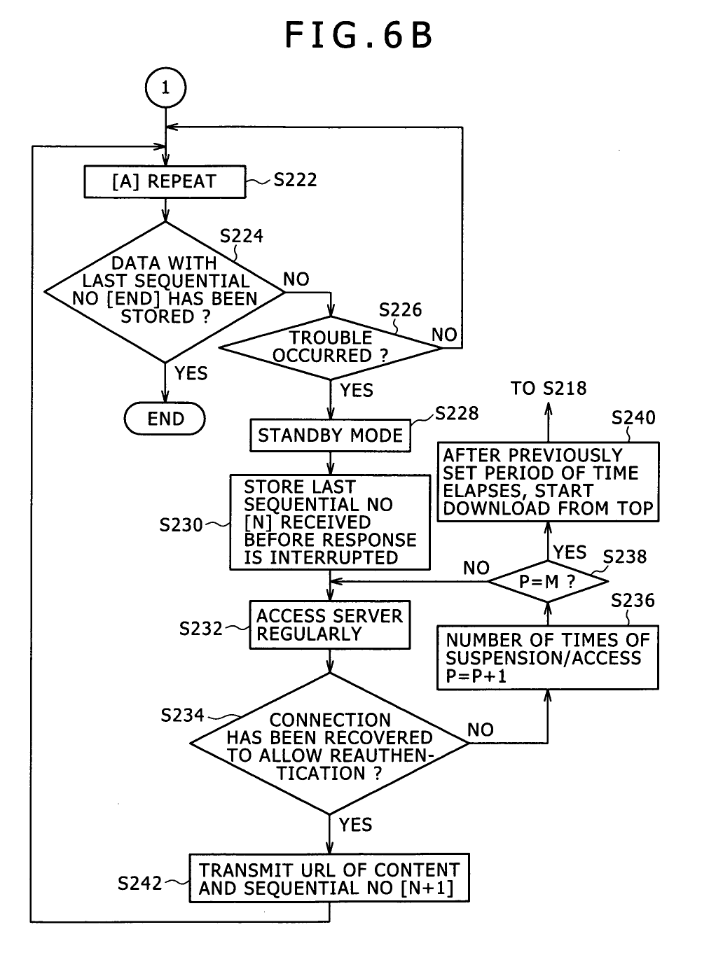

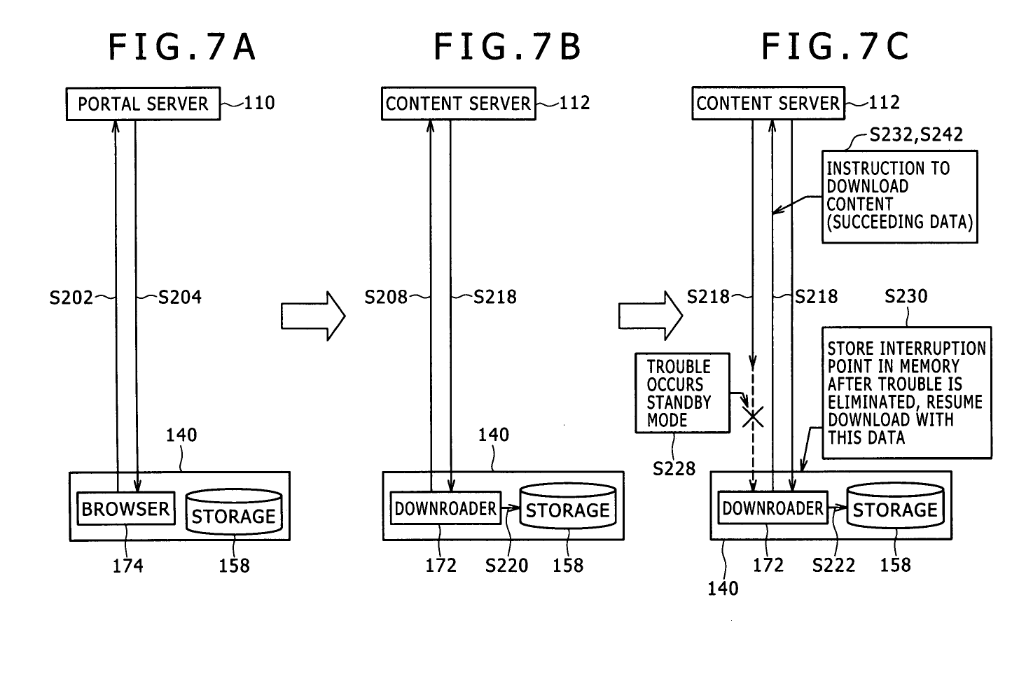

Next, an operation of the reception terminal will now be described below with reference to FIGS. 6A, 6B, and 7. FIGS. 6A and 6B are flowcharts illustrating the operation of the content delivery system 100 according to the present embodiment. FIG. 7 is a diagram illustrating a download sequence of the content delivery system 100 according to the present embodiment.

As a result of the operation by the user who desires to use the content delivery system 100, the reception terminal 140 accesses the delivery server 102. At this time, the reception terminal 140 is connected to the portal server 110 based on the destination of the selected link (step S202). If the portal server 110 authenticates the reception terminal 140, the reception terminal 140 acquires the metadata from the portal server 110 (step S204). Examples of the metadata include data concerning the ECG, such as a list of titles of pieces of downloadable content data. Next, based on the list acquired, the browser 174 in the reception terminal 140 displays the list of the titles of the contents or the like on the display device 180 (step S206). Using the list displayed, the user is able to select a content. Then, the user selects the content that the user desires to download, thereby issuing the instruction to download the content data (step S208).

Next, based on the instruction to download, the reception terminal 140 accesses the content server 112, the metadata server 114, and the DRM server 116 via the portal server 110. The reception terminal 140 acquires the content meta information from the metadata server 114 (step S210), acquires the reproduction control metafile from the content server 112 (step S212), and acquires license meta information from the DRM server 116 (step S214).

Next, the reception terminal 140 performs the process of controlling the storage of the acquired reproduction control metafile, and the reception terminal 140 stores the reproduction control metafile in the storage 158 (step S216).

Next, the reception terminal 140 requests, from the content server 112, the media file of the content data desired by the user, and thereafter downloads the media file from the content server 112 (step S218).

The reception terminal 140 stores the received media file in the storage 158 (step S220). The media file is delivered (downloaded) on an encrypted block by encrypted block basis and thus stored in the storage 158. The processes of steps S218 and S220 are repeated ([A] in FIG. 6A) to progress the delivery of the media file (step S222).

The reception terminal 140 checks the sequential number stored in the encrypted block of the media file, and determines whether data that has stored in the storage 158 has the last sequential number of the media file (step S224). If it is determined that the last sequential number of the media file has been stored by referring to the content meta information, which has previously been downloaded and in which the last sequential number is stored, the download is completed.

However, while the delivery of the media file is in progress, a trouble or the like may occur in the content delivery system 100, so that the delivery of the media file is interrupted (step S226). If the reception terminal 140 detects the interruption, the reception terminal 140 shifts to the standby mode, in which the reception terminal 140 suspends the reception of the content (step S228). At this time, the interruption point is recorded in the interruption point recording section in the reception terminal 140. The interruption point recorded at this time is, for example, the last sequential number (e.g., sequential number [N]) that has been received before the response is interrupted.

When the predetermined period of time has elapsed after the reception terminal 140 entered the standby mode, the reception terminal 140 shifts to the resume mode. In the resume mode, the reception terminal 140 accesses the delivery server 102 regularly to request the delivery of the media file based on the interruption point information recorded in the interruption point recording section (step S232).

Then, the reception terminal 140 determines whether connection has been recovered to allow reauthentication as a result of the trouble in the content delivery system 100 having been eliminated (step S234).

If the trouble in the content delivery system 100 has been eliminated, the delivery of the media file is resumed. At this time, the downloader 172 transmits, to the content server 112, the interruption point information and the information representing the media file, such as the URL information of the content, thereby making the request for the media file, for example. The interruption point information is a number obtained by adding one to the last sequential number that had been received before the response was interrupted. In this manner, the download can be resumed with a first encrypted block that has not been downloaded yet. In the case where sequential number [N] is recorded in the interruption point recording section for example, the interruption point notification section notifies the interruption point acquisition section of sequential number [N+1].

On the other hand, if the trouble in the content delivery system 100 has not been eliminated, and the connection has not been recovered to allow reauthentication, the delivery server 102 or the reception terminal 140 returns to the standby mode. Then, the number of times of suspension/access (denoted as P, for example) is incremented by one, and P+1 is recorded.

Next, it is determined whether the number P of times of suspension/access has reached a predetermined maximum number M for the number P of times of suspension/access (step S238). If it is determined that the number P of times of suspension/access has not reached the maximum number M yet, the reception terminal 140 shifts to the resume mode again, and accesses the server regularly (step S232). Meanwhile, if it is determined that the number P of times of suspension/access has reached the maximum number M, that means that the trouble has not been eliminated for a certain period of time. In that case, the data structure of the media file may be changed, and therefore the media file that has been downloaded halfway is erased, and after a previously set period of time elapses, the reception terminal 140 may start the download of the media file again from the top of the media file (step S240). Thereafter, the processes of step S218 and the subsequent steps are performed.

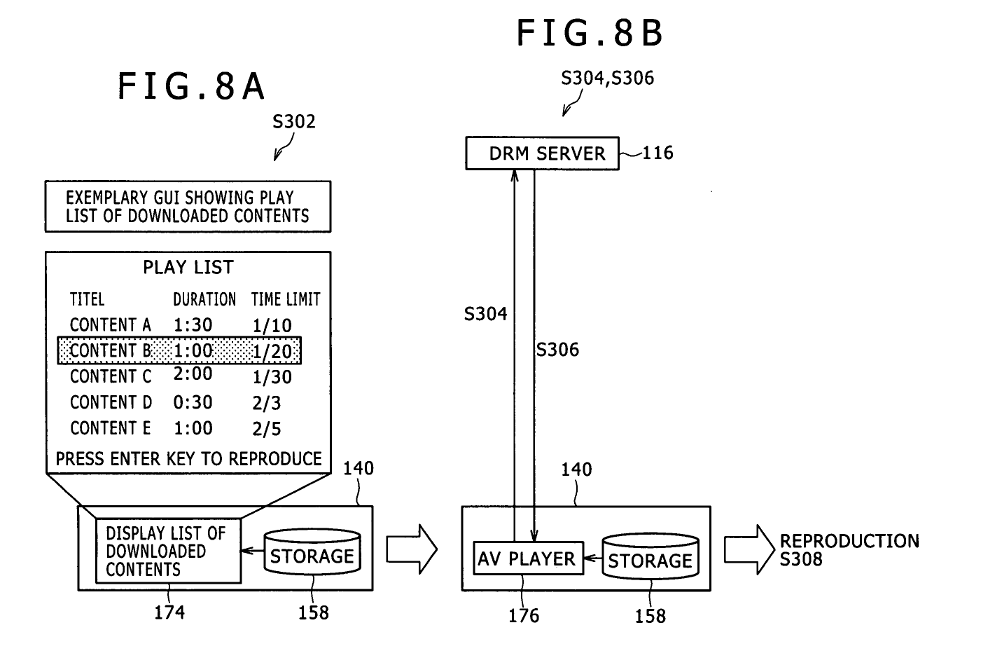

Next, an operation of reproducing the downloaded content according to the present embodiment will now be described below with reference to FIG. 8. FIG. 8 is a diagram illustrating a sequence of reproducing the downloaded content according to the present embodiment.

The browser 174 displays a list of contents that are stored in the storage 158 and which can be reproduced. FIG. 8 shows an exemplary GUI showing a play list of downloaded contents.

Using the displayed list, the user is able to select a desired content. Then, the user selects the content that the user desires to reproduce, thereby issuing an instruction to reproduce the content data (step S302).

If the selected content is reproducible, the AV player 176, which is application software for reproducing the content, is started in the reception terminal 140. Then, the AV player 176 requests the license, i.e., a permission to reproduce the content, from the DRM server 116 (step S304). The DRM server 116 determines whether the reception terminal 140 meets the requirement for the issuance of the license, and if the reception terminal 140 meets the requirement for the issuance of the license, the DRM server 116 issues the license (step S306). The reception terminal 140 receives the license from the DRM server 116, and thereafter the reception terminal 140 is able to reproduce the content data (step S308).

According to the above-described embodiment of the present invention, if the communication trouble or the like occurs and the download of the content data is interrupted, the download of the content data will be resumed with the first encrypted block that remains to be delivered based on the interruption point information. Thus, a time required for the download of the content data can be shortened. Moreover, after the predetermined period of time elapses, the delivery server or the reception terminal attempts to resume the delivery of the content data regularly based on the interruption point information. This eliminates the need for the user to perform an additional operation, and without the need for the user to perform any additional operation, the download of the content data will be automatically completed after the trouble is eliminated. Still further, after the download of the content data is resumed, only that part of the content data which has not been downloaded yet is delivered, while that part of the content data which has already been downloaded to the reception terminal is not delivered again. Thus, the network can be used efficiently. Still further, in related art, when a trouble occurs and the download of the content data is interrupted, the download of the content data is restarted from the top of the content data. In comparison to such related art, the above-described embodiment of the present invention achieves a reduction in the time required for the download. Still further, in the case where the interruption point recording section, which is used to record the interruption point of the content data when the download of the content data has been interrupted, is provided in the reception terminal, the reception terminal is capable of managing the download, facilitating the management on the part of the delivery server.

While a preferred embodiment of the present invention has been described above with reference to the accompanying drawings, it will be appreciated that the present invention is not limited to the above-described embodiment. It should be understood by those skilled in the art that various modifications, combinations, sub-combinations and alterations may occur depending on design requirements and other factors insofar as they are within the scope of the appended claims or the equivalents thereof.

1. A content delivery system, comprising:
a delivery server configured to deliver content data;
a terminal configured to download the content data from said delivery server; and
a network to which said delivery server and said terminal are connected, wherein
said delivery server includes,
an encryption section configured to perform block encryption on the content data to divide the content data into a plurality of encrypted blocks and add point information to each of the encrypted blocks, and
a delivery section configured to deliver the content data to said terminal on an encrypted block by encrypted block basis,
said terminal includes a reception section configured to receive the content data delivered from the delivery section on an encrypted block by encrypted block basis,
said terminal or said delivery server includes an interruption point recording section configured to, when reception of the content data has been interrupted in said terminal, record the point information of a last encrypted block that has been received as interruption point information,
said delivery server includes an interruption point acquisition section configured to acquire the interruption point information recorded in the interruption point recording section, and
based on the interruption point information acquired by the interruption point acquisition section, the delivery section starts delivery of one or more of the encrypted blocks of the content data that remain to be delivered to said terminal.

2. The content delivery system according to claim 1, wherein
when the reception of the content data has been interrupted in said terminal, said delivery server or said terminal shifts to a standby mode in which the delivery of the content data is suspended for a predetermined period of time, and
after the predetermined period of time elapses, the delivery section enters a resume mode in which the delivery section starts the delivery of the one or more of the encrypted blocks of the content data that remain to be delivered to said terminal based on the interruption point information acquired by the interruption point acquisition section.

3. The content delivery system according to claim 2, wherein if the reception of the content data is not resumed in said terminal even when the delivery section has entered the resume mode, said delivery server or said terminal shifts to the standby mode again, and after the predetermined period of time elapses, the delivery section enters the resume mode, and this back-and-forth mode shift is repeated until the reception of the content data is resumed in said terminal.

4. The content delivery system according to claim 3, wherein if the back-and-forth mode shift has been repeated a predetermined number of times because the reception of the content data is not resumed in said terminal even when the delivery section has entered the resume mode, the delivery section starts the delivery of the content data from a top of the content data.

5. A delivery server for delivering content data to a terminal for downloading the content data via a network, the delivery server comprising:
an encryption section configured to perform block encryption on the content data to divide the content data into a plurality of encrypted blocks and add point information to each of the encrypted blocks;
a delivery section configured to deliver the content data to the terminal on an encrypted block by encrypted block basis; and
an interruption point acquisition section configured to, when reception of the content data has been interrupted in the terminal, acquire the point information of a last encrypted block that has been received by the terminal as interruption point information, wherein
based on the interruption point information acquired by said interruption point acquisition section, said delivery section starts delivery of one or more of the encrypted blocks of the content data that remain to be delivered to the terminal.

6. The delivery server according to claim 5, further comprising an interruption point recording section configured to, when the reception of the content data has been interrupted in the terminal, record the point information of the last encrypted block that has been received by the terminal as the interruption point information.

7. A terminal for downloading content data from a delivery server for delivering the content data via a network, the content data having been subjected to block encryption in the delivery server so that the content data has been divided into a plurality of encrypted blocks and point information has been added to each of the encrypted blocks, the terminal comprising:
a reception section configured to receive the content data from the delivery server on an encrypted block by encrypted block basis, wherein
when reception of the content data has been interrupted in the terminal, said reception section starts reception of one or more of the encrypted blocks of the content data that remain to be received based on interruption point information, the interruption point information being the point information of a last encrypted block that has been received.

8. The terminal according to claim 7, further comprising:
an interruption point recording section configured to record the interruption point information when the reception of the content data has been interrupted; and
an interruption point notification section configured to notify the delivery server of the interruption point information recorded in said interruption point recording section.

9. A content delivery method employed in a network to which a delivery server for delivering content data and a terminal for downloading the content data are connected, the method comprising:
the delivery server performing block encryption on the content data to divide the content data into a plurality of encrypted blocks and add point information to each of the encrypted blocks;
the delivery server delivering the content data to the terminal on an encrypted block by encrypted block basis;
the terminal receiving the content data delivered from the delivery server on an encrypted block by encrypted block basis;
when reception of the content data has been interrupted in the terminal, the terminal or the delivery server recording the point information of a last encrypted block that has been received as interruption point information;
the delivery server acquiring the interruption point information recorded in said recording step; and
based on the interruption point information acquired in said acquiring step, the delivery server starting delivery of one or more of the encrypted blocks of the content data that remain to be delivered to the terminal.
